(19) United States
(12) Patent Application Publication
(10) Pub. No.: US 2007/0146770 A1
(43) Pub. Date: Jun. 28, 2007

(54) Image processing apparatus

(75) Inventor: Yukihiro Saida, Tokyo (JP)

Correspondence Address: TAKEUCHI & KUBOTERA, LLP, 200 DAINGERFIELD ROAD, SUITE 202, ALEXANDRIA, VA, 22314, US

(73) Assignee: Oki Data Corporation

(21) Appl. No.: 11/642,588

(22) Filed: Dec. 21, 2006

(30) Foreign Application Priority Data
Dec. 28, 2005 (JP) 2005-379033

(51) Int. Cl. G06K 15/00

(52) U.S. Cl. 358/1.14; 358/448

(57) ABSTRACT

An image processing apparatus includes a job storage unit for receiving and storing a plurality of jobs together with characteristic information of the jobs; a characteristic information specifying unit for specifying information corresponding to the characteristic information; a job searching unit for searching for a job having the information specified by the characteristic information specifying unit from the jobs stored in the job storage unit; and a job terminating unit for temporarily terminating the job searched by the job searching unit.

### BACKGROUND OF THE INVENTION AND RELATED ART STATEMENT

The present invention relates to an image processing apparatus having a plurality of functions, in particular, an image processing apparatus capable of deleting a specific processing in the middle of image processing.

Patent Reference has disclosed a conventional image forming apparatus capable of deleting a specific processing in the middle of an image forming process. In the conventional image processing apparatus, an operation display unit is provided for selecting one of steps of temporarily terminating a job in the middle of processing the job and clearing the job when the termination of the job processing is requested in the middle of the image forming process. Accordingly, it is possible to restart the job after temporarily terminating the job without performing an unnecessary operation of the apparatus.

Patent Reference: Japanese Patent Publication No. 2002-139964

In the conventional image forming apparatus having a plurality of functions, when having a plurality of image processing modes is concurrently performed in parallel, it is necessary to terminate jobs of the image processing modes that do not need to be terminated.

In view of the problems described above, an object of the present invention is to provide an image processing apparatus having a plurality of functions, in particular, an image processing apparatus capable of deleting a specific processing in the middle of image processing.

Further objects and advantages of the invention will be apparent from the following description of the invention.

### SUMMARY OF THE INVENTION

In order to attain the objects described above, according to one aspect of the present invention, an image processing apparatus comprises: a job storage unit for receiving and storing a plurality of jobs together with characteristic information of the jobs; a characteristic information specifying unit for specifying information corresponding to the characteristic information; a job searching unit for searching for a job having the information specified by the characteristic information specifying unit from the jobs stored in the job storage unit; and a job terminating unit for temporarily terminating the job searched by the job searching unit.

In the image processing apparatus, the characteristic information specifying unit is provided for specifying the characteristic information that the job has. More specifically, a function type specifying unit is provided for specifying a type of processing function. Accordingly, it is possible to temporarily terminate only the processing of the job having a mode same as that of the job that needs to be cleared. As a result, it is not necessary to terminate the jobs having the other modes that do not need to be temporarily terminated, thereby improving processing efficiency of the job.

### BRIEF DESCRIPTION OF THE DRAWINGS

FIG. 1 is a schematic block diagram showing an image processing apparatus according to a first embodiment of the present invention;

FIG. 2(a) is a schematic view showing an example of information related to a job according to the first embodiment of the present invention, FIG. 2(b) is a schematic view showing an example of a job list according to the first embodiment of the present invention, and FIG. 2(c) is a schematic view showing an example of a temporary termination list according to the first embodiment of the present invention;

FIG. 3 is a schematic view showing an example of a panel display according to the first embodiment of the present invention;

FIG. 4 is a flow chart showing an operation of a job storage process according to the first embodiment of the present invention;

FIG. 5 is a flow chart showing an operation of a request for storing the information related to the job according to the first embodiment of the present invention;

FIG. 6 is a flow chart showing an operation of a job clear process according to the first embodiment of the present invention;

FIG. 7 is a flow chart showing an operation of a job execution process according to the first embodiment of the present invention;

FIG. 8 is a flow chart showing an operation of a job setting process according to the first embodiment of the present invention;

FIG. 9 is a flow chart showing an operation of a job clear pre-processing according to the first embodiment of the present invention;

FIG. 10 is a flow chart showing an operation of a job clear process according to the first embodiment of the present invention;

FIG. 11 is a schematic block diagram showing an image processing apparatus according to a second embodiment of the present invention;

FIG. 12 is a schematic view showing an example of information related to a job according to the second embodiment of the present invention;

FIG. 13 is a schematic view showing an example of a panel display according to the second embodiment of the present invention;

FIG. 14 is a flow chart showing an operation of a job storage process according to the second embodiment of the present invention;

FIG. 15 is a flow chart showing an operation of a user authentication process according to the second embodiment of the present invention;

FIG. 16 is a flow chart showing an operation of a request for storing the information related to the job according to the second embodiment of the present invention;

FIG. 17 is a flow chart showing an operation of a job clear process according to the second embodiment of the present invention; and

FIG. 18 is a flow chart showing an operation of a job clear pre-processing according to the second embodiment of the present invention.

### DETAILED DESCRIPTION OF PREFERRED EMBODIMENTS

Hereunder, embodiments of the present invention will be explained with reference to the accompanying drawings.

### First Embodiment

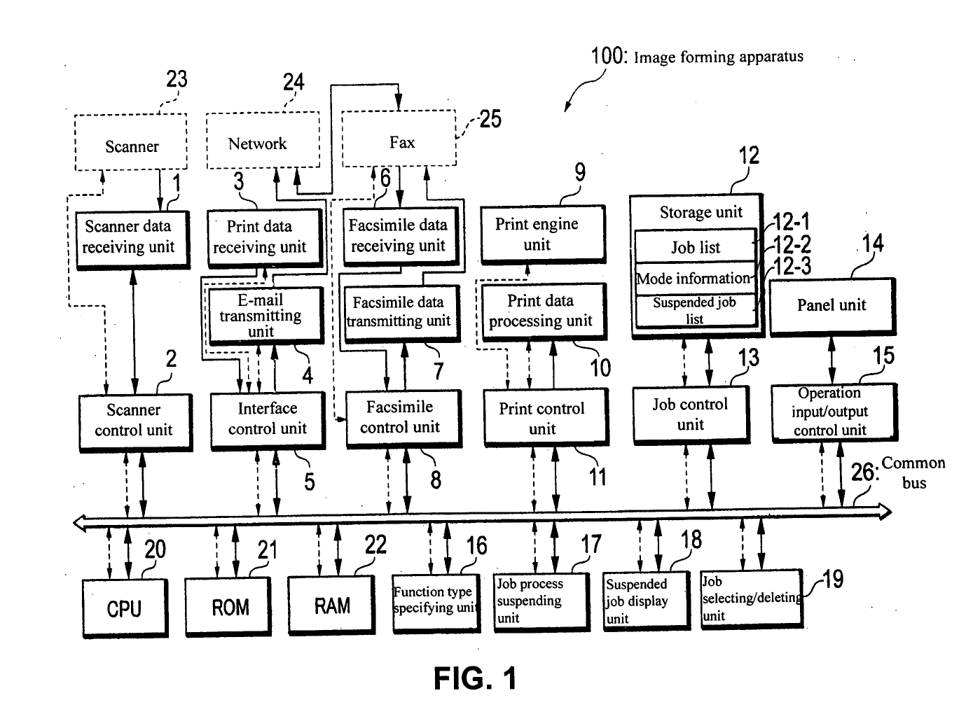

FIG. 1 is a schematic block diagram showing an image processing apparatus according to a first embodiment of the present invention. The image processing apparatus of the first embodiment, i.e., an image processing apparatus 100, is a multifunctional device having functions such as those of facsimile, copier, and printer.

As shown in FIG. 1, the image forming apparatus 100 is provided with a scanner data receiving unit 1; a scanner control unit 2; a print data receiving unit 3; an e-mail transmitting unit 4; an interface control unit 5; a facsimile data receiving unit 6; a facsimile data transmitting unit 7; a facsimile control unit 8; a print engine unit 9; a print data processing unit 10; a print control unit 11; a storage unit 12; a job control unit 13; a panel unit 14; an operation input/output control unit 15; a function type specifying unit 16; a job process terminating unit 17; a terminated job display unit 18; a job selecting/deleting unit 19; a CPU 20; an ROM 21; an RAM 22; and a common bus 26.

The scanner data receiving unit 1 receives scanner data (image information) from a scanning device 23, and transmits the scanner data to the scanner control unit 2. The scanner control unit 2 controls the scanner device 23 to obtain image information from an original image and transmit the image information as the scanner data to the scanner data receiving unit 1. The scanner control unit 2 also creates a job according to the scanner data. The scanner control unit 2 includes blocked computer control functions to be started and created upon starting a specific program stored in advance in the ROM 21. In the embodiment, the scanner device 23 (indicated by hidden line frame in FIG. 1) is a device separated from the image forming apparatus 100, and may be a part of the image forming apparatus 100.

The print data receiving unit 3 receives print data from an upper device (not shown) through a network 24 (including USB), and transmits the print data to the interface control unit 5. The e-mail transmitting unit 4 transmits an email to an upper device (not shown) through the network 24 (including USB) according to control of the interface control unit 5.

The interface control unit 5 controls the print data receiving unit 3 and the e-mail transmitting unit 4 to receive the print data from an upper device (not shown) through the network 24 (including USB), and to transmit an email to an upper device (not shown). The interface control unit 5 also creates a job according to the print data. The interface control unit 5 includes blocked computer control functions to be started and created when the CPU 20 executes a specific program stored in advance in the ROM 21.

The facsimile data receiving unit 6 receives facsimile data from an upper device (not shown) through the network 24 and a facsimile device 25, and transmits the print data to the facsimile control unit 8. The facsimile data transmitting unit 7 receives the facsimile data from the facsimile control unit 8, and transmits the facsimile data to an upper device (not shown) through the network 24 and the facsimile device 25. The facsimile control unit 8 controls the facsimile data receiving unit 6 and the facsimile data transmitting unit 7 to communicate with an upper device (not shown). The facsimile control unit 8 also creates a job according to the facsimile data. The facsimile control unit 8 includes blocked computer control functions to be started and created when the CPU 20 executes a specific program stored in advance in the ROM 21.

In the embodiment, the facsimile device 25 (indicated by hidden line frame in FIG. 1) is a device separated from the image forming apparatus 100, and may be a part of the image forming apparatus 100.

The print engine unit 9 receives print data from the print data processing unit 10 according to control of the print control unit 11, and prints and outputs the print data. The print data processing unit 10 receives image data from the print control unit 11, and converts the image data to the print data, so that the print data processing unit 10 sends the print data to the print engine unit 9. The print control unit 11 receives various types of data through the scanner control unit 2, the interface control unit 5, and the facsimile control unit 8 to execute a specific data processing, and converts the data to the image data, so that the print control unit 11 sends the image data to the print data processing unit 10. Further, the print control unit 11 controls the print engine unit 9 to output an image. The print control unit 11 includes blocked computer control functions to be started and created when the CPU 20 executes a specific program stored in advance in the ROM 21.

The storage unit 12 is a memory for storing information related to a job according to control of the job control unit 13. In the embodiment, the storage unit 12 includes memory sections for separately storing a job list 12-1; mode information 12-2; and a temporary termination list 12-3, respectively. The job list 12-1 is the memory section for storing a list of information related to a job that a user requests processing thereof.

The job list 12-1 will be explained in detail next. Note that the job list 12-1 stores only the information related to a job (job related information), and does not store the print data and the likes. The data to be processed are temporarily stored in specific buffers disposed in the scanner data receiving unit 1, the print data receiving unit 3, and the facsimile data receiving unit 6, respectively.

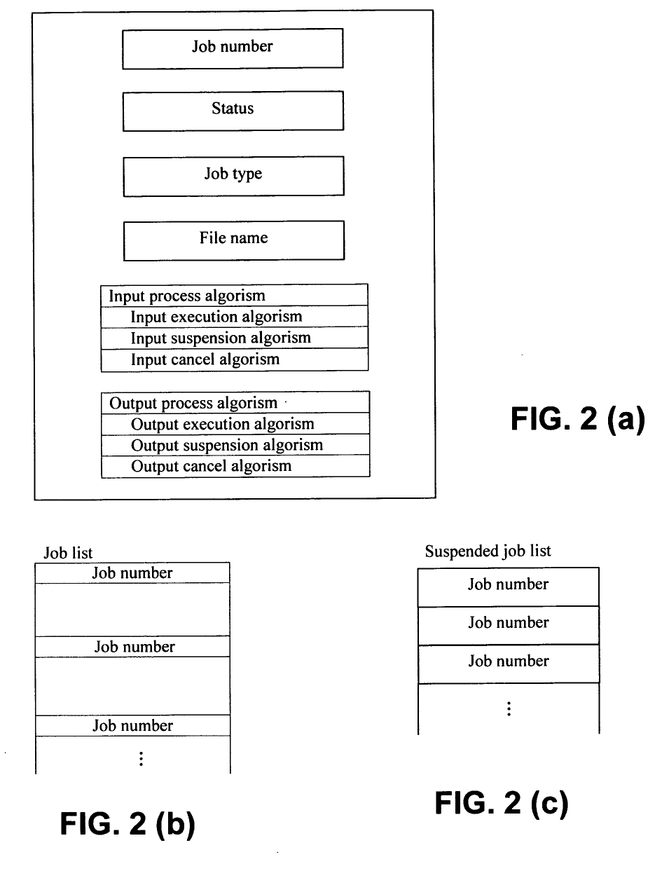

FIG. 2(a) is a schematic view showing an example of information related to a job according to the first embodiment of the present invention. As shown in FIG. 2(a), the information includes a job number of the corresponding job; a status for directing execution, termination, or cancel of the job; a job type (mode information) for indicating copy, print, FAX, E-mail, and the likes; a file name; and process algorism information related to input/output for processing the job.

In the job number, every time a user inputs a request, a different number is assigned to a generated job. In the status, when a user requests execution, an execution state is set; when a user selects a mode, a termination state is set; and when a user cancels, a cancel state is set. In the job type, a type of request (copy, print, facsimile, mail, and the likes) is indicated.

The process algorism information will be explained next. When the corresponding job is a request for copy processing, the process algorism information on the input side is a process algorism for controlling the scanner control unit 2 to receive the scanner data through the scanning device 23 and the scanner data receiving unit 1. In the process algorism information on the input side, a process algorism to be retrieved at three stages, i.e., execution state, termination state, and cancel state, respectively, is registered.

The process algorism information on the output side is a process algorism for controlling the print control unit 11 to convert the scanner data to the print data, so that the print engine unit 9 prints and outputs. In the process algorism information on the output side, a process algorism to be retrieved at three stages, i.e., execution state, termination state, and cancel state, respectively, is registered.

FIG. 2(b) is a schematic view showing an example of the job list according to the first embodiment of the present invention. FIG. 2(c) is a schematic view showing an example of the temporary termination list according to the first embodiment of the present invention. A job number corresponding to a job type (mode information) that a user requests for temporary termination is retrieved from the job list and displayed in the temporary termination list.

The mode information 12-2 shown in FIG. 1 is the memory section for receiving and storing the mode information of the job that a user requests for temporary termination thereof through the panel unit 14. The temporary termination list 12-3 is the memory section for storing the job number temporarily terminated.

The job control unit 13 executes control and operation (execution) of a job using information (FIG. 2) related to the job and stored in the storage unit 12. Further, the job control unit 13 controls the storage unit 12 to create a list of a job temporarily terminated. The job control unit 13 includes blocked computer control functions to be started and created when the CPU 20 executes a specific program stored in advance in the ROM 21.

The panel unit 14 is a display panel for, together with the operation input/output control unit 15, sharing a function of a man-machine interface between the apparatus and a user. The operation input/output control unit 15 receives a request from a user through the panel unit 14, and displays contents of the storage unit 12 on the panel unit 14 for providing information for the user. The operation input/output control unit 15, together with the panel unit 14, shares the function of the man-machine interface between the apparatus and a user. The operation input/output control unit 15 includes blocked computer control functions to be started and created when the CPU 20 executes a specific program stored in advance in the ROM 21.

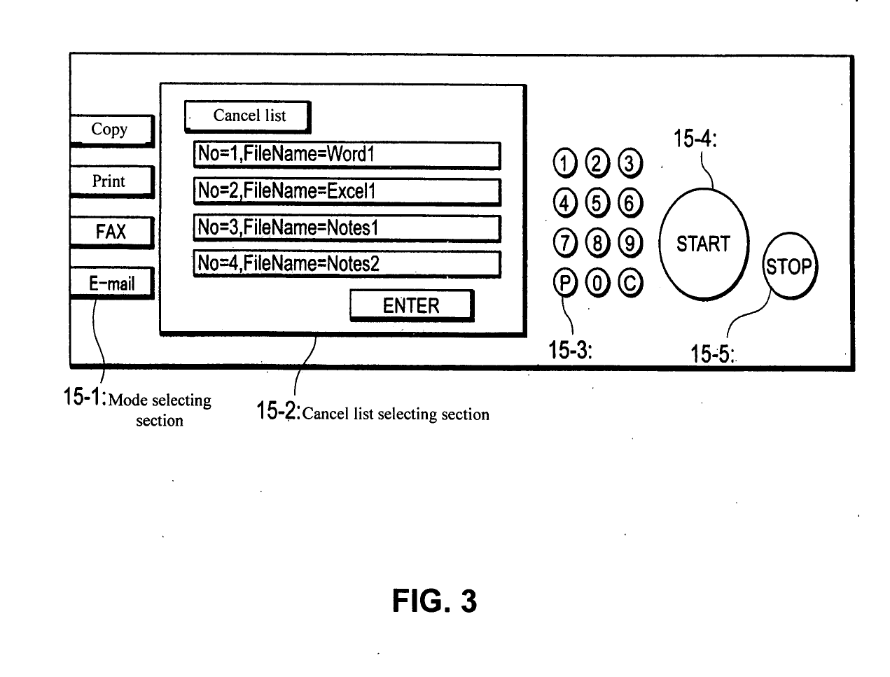

An example of the panel display will be explained next. FIG. 3 is a schematic view showing an example of the panel display according to the first embodiment of the present invention. As shown in FIG. 3, there are arranged a mode selecting section 15-1 for inputting a mode that a user requests for temporarily terminating a job thereof; a cancel list selecting section 15-2 for selecting a job that a user requests for clearing thereof; a ten-key 15-3 for inputting data; a start switch 15-4; and a stop switch 15-5.

The function type specifying unit 16 shown in FIG. 1 specifies a type of function of a job that a user requests for clearing thereof according to an input setting executed by the user through the mode selecting section 15-1 of the panel unit 14. Further, the function type specifying unit 16 notifies the job control unit 13 of the type of function, so that the type of function is stored in the mode information 12-2. The function type specifying unit 16 includes blocked computer control functions to be started and created when the CPU 20 executes a specific program stored in advance in the ROM 21.

The job process terminating unit 17 temporarily terminates processing of a job corresponding to the type of function specified by the function type specifying unit 16. Further, the job process terminating unit 17 notifies the job control unit 13 of the type of function thus terminated, so that the type of function is stored in the temporary termination list 12-3. The job process terminating unit 17 includes blocked computer control functions to be started and created when the CPU 20 executes a specific program stored in advance in the ROM 21.

The terminated job display unit 18 directs the job control unit 13 and the operation input/output control unit 15 to display a job stored in the temporary termination list 12-3 that processing thereof is terminated on the cancel list selecting section 15-2 (FIG. 3) of the panel unit 14. The terminated job display unit 18 includes blocked computer control functions to be started and created when the CPU 20 executes a specific program stored in advance in the ROM 21.

The job selecting/deleting unit 19 prompts a user to select a job to be deleted among the jobs temporarily terminated according to the display on the cancel list selecting section 15-2 (FIG. 3) of the panel unit 14, so that the selected job is deleted. The job selecting/deleting unit 19 includes blocked computer control functions to be started and created when the CPU 20 executes a specific program stored in advance in the ROM 21.

The CPU 20 is a microprocessor for controlling the apparatus as a whole. In the embodiment, when the CPU 20 executes a specific program stored in the ROM 21, it is possible to start and create the scanner control unit 2; the interface control unit 5; the facsimile control unit 8; the print control unit 11; the job control unit 13; the operation input/output control unit 15; the function type specifying unit 16; the job process terminating unit 17; the terminated job display unit 18; and the job selecting/deleting unit 19.

The ROM 21 is a read-only memory for storing a control program, so that when the CPU 20 executes the control program, it is possible to start and create the scanner control unit 2; the interface control unit 5; the facsimile control unit 8; the print control unit 11; the job control unit 13; the operation input/output control unit 15; the function type specifying unit 16; the job process terminating unit 17; the terminated job display unit 18; and the job selecting/deleting unit 19. The RAM 22 is a random access memory for providing an algorism processing area necessary for the CPU 20 to execute the control program.

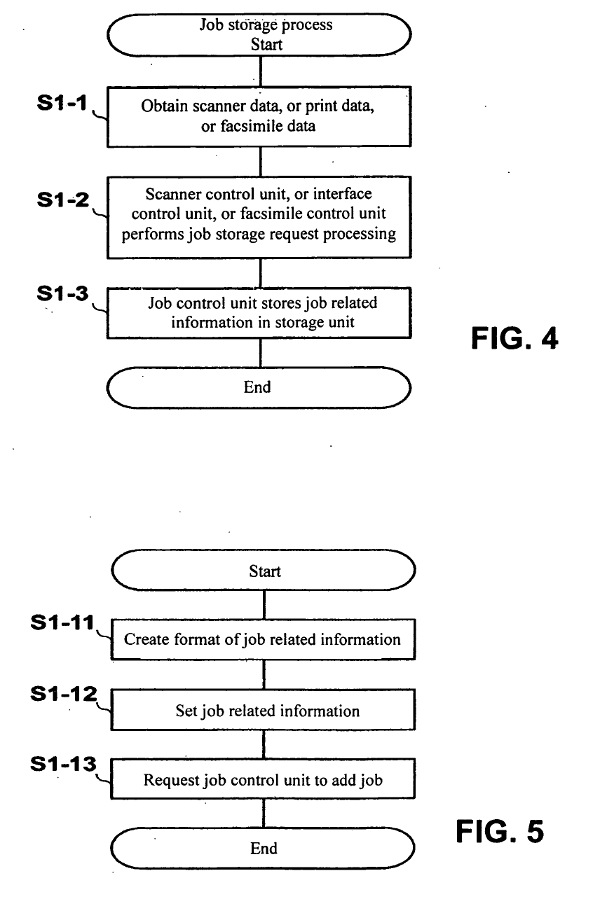

An operation of the image forming apparatus according to the first embodiment of the present invention will be explained next. First, an operation will be explained, in which the image forming apparatus 100 receives the various data to create a job, and the information related to the job (job related information) is stored in the job list 12-1 of the storage unit 12. Second, an operation will be explained, in which the specific job among the jobs is cleared according to the user request. FIG. 4 is a flow chart showing an operation of a job storage process according to the first embodiment of the present invention

In step S1-1, the scanner data receiving unit 1 (FIG. 1) receives the scanner data and sends the scanner data to the scanner control unit 2 (FIG. 1). Alternatively, the print data receiving unit 3 (FIG. 1) receives the print data and sends the print data to the interface control unit 5 (FIG. 1). Alternatively, the facsimile data receiving unit 6 (FIG. 1) receives the facsimile data and sends the facsimile data to the facsimile control unit 8 (FIG. 1).

In step S1-2, the scanner control unit 2 (FIG. 1), the interface control unit 5 (FIG. 1), or the facsimile control unit 8 (FIG. 1) creates the job according to the received data. Then, the created job is stored in the specific buffer disposed in the scanner data receiving unit 1 (FIG. 1), the print data receiving unit 3 (FIG. 1), or the facsimile data receiving unit 6 (FIG. 1). Further, the information related to the job (for example, the type of job, the file name, and the likes) is sent to the job control unit 13 (FIG. 1), so that it is requested to store the information in the storage unit 12 (FIG. 1).

In step S1-3, the job control unit 13 (FIG. 1) obtains the job number, and stores the information related to the job thus received and the related information in the job list 12-1 of the storage unit 12 (FIG. 1), thereby completing the process. The status information is set to execution.

The operation in step S1-2 will be explained in more detail with reference to another flow chart. FIG. 5 is the flow chart showing the operation of the request for storing the information related to the job according to the first embodiment of the present invention. The flow chart shown in FIG. 5 is a detailed flow chart for explaining step S1-2.

In step 1-11, when the scanner control unit 2 (FIG. 1) receives the scanner data from the scanner data receiving unit 1 (FIG. 1), or the interface control unit 5 (FIG. 1) receives the print data from the print data receiving unit 3 (FIG. 1), or the facsimile control unit 8 (FIG. 1) receives the facsimile data from the facsimile data receiving unit 6 (FIG. 1), the respective control unit (the scanner control unit 2 (FIG. 1), the interface control unit 5 (FIG. 1), or the facsimile control unit 8 (FIG. 1)) creates the job and temporarily stores the job in the corresponding receiving unit (the scanner data receiving unit 1 (FIG. 1), the print data receiving unit 3 (FIG. 1), or the facsimile data receiving unit 6 (FIG. 1)). Further, the respective control unit (the scanner control unit 2 (FIG. 1), the interface control unit 5 (FIG. 1), or the facsimile control unit 8 (FIG. 1)) creates the job related information (FIG. 2).

In step S1-12, the respective control unit (the scanner control unit 2 (FIG. 1), the interface control unit 5 (FIG. 1), or the facsimile control unit 8 (FIG. 1)) sets the job related information (the job type, the file name and the likes in FIG. 2) to the format of the job related information shown in FIG. 2.

In step S1-13, the respective control unit (the scanner control unit 2 (FIG. 1), the interface control unit 5 (FIG. 1), or the facsimile control unit 8 (FIG. 1)) sends the job related information to the job control unit 13 (FIG. 1) for adding to the job list, thereby completing the process.

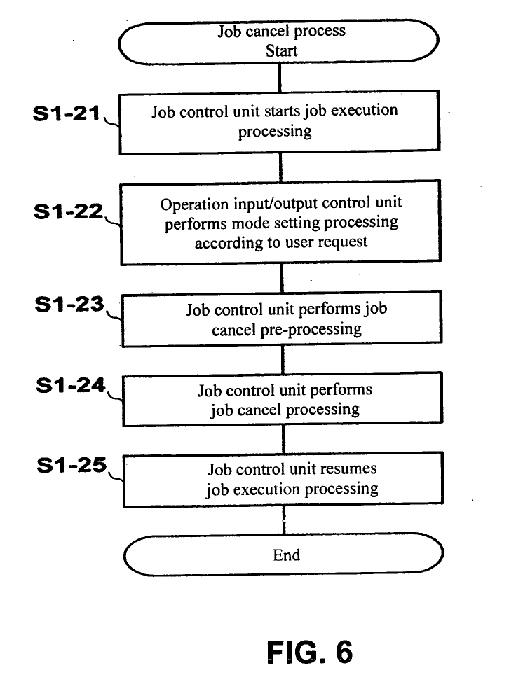

An operation of clearing the specific job from the job list 12-1 stored in the storage unit 12 (FIG. 1) according to the user request will be explained next. FIG. 6 is a flow chart showing the operation of the job clear process according to the first embodiment of the present invention.

In step S1-21, the job control unit 13 (FIG. 1) starts the operation (execution) of the job in a specific order (described later). That is, the process algorism is retrieved from the input/output process algorisms registered in the job related information (FIG. 2) in the job list 12-1, thereby starting the execution process of the job.

In step S1-22, during the execution process of the job, the operation input/output control unit 15 (FIG. 1) performs the mode setting process according to the user request (input to the panel unit 14 (FIG. 1)). In step S1-23, the job control unit 13 (FIG. 1) performs a specific pre-processing (described later) for clearing the job. In step S1-24, the job control unit 13 (FIG. 1) clears the job in a specific order (described later). In step S1-25, the job control unit 13 (FIG. 1) resumes the operation (execution) of the job in a specific order (described later).

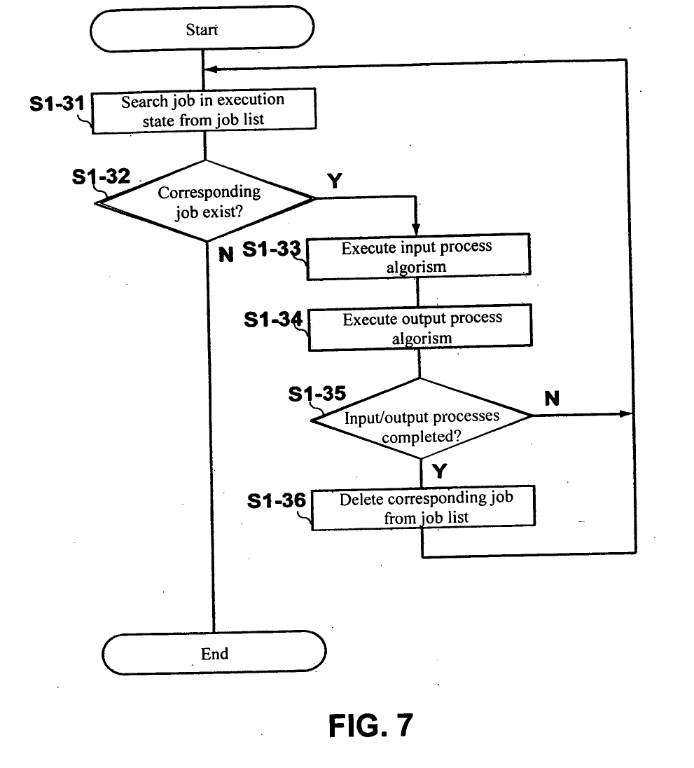

The process from step S1-21 to step S1-25 will be explained in more detail with reference to another flow chart. FIG. 7 is the flow chart showing an operation of the job execution process according to the first embodiment of the present invention. The flow chart shown in FIG. 7 is a detailed process of step S1-21.

In step S1-31, the job control unit 13 (FIG. 1) searches for the job having the status information in an execution state from the job list 12-1. In step S1-32, when the job control unit 13 (FIG. 1) does not find the job, the process ends. When the job control unit 13 (FIG. 1) finds the job, the process proceeds to step S1-33. In step S1-33, the job control unit 13 (FIG. 1) retrieves the input process algorism from the information related to the job thus found, so that the corresponding control unit performs the execution process.

In Step S1-34, the job control unit 13 (FIG. 1) retrieves the output process algorism from the information related to the job thus found, so that the corresponding control unit performs the execution process. Suppose that the job thus found is the request for copy processing. In this case, in the process (process algorism) on the input side, the scanner control unit 2 receives the scanner data through the scanning device 23 and the scanner data receiving unit 1. In the process (process algorism) on the output side, the print control unit 11 converts the scanner data to the print data, so that the print engine unit 9 prints and outputs. Accordingly, the scanner control unit 2 performs the reception of the scanner data, and the print control unit 11 performs the printing and outputting.

In step S1-35, the job control unit 13 (FIG. 1) repeats the process from step S1-31 to step S1-35 until the processes on the input side and the output side are completed. Upon completion, the process proceeds to step S1-36. In step S1-36, the job control unit 13 (FIG. 1) deletes' the information related to the corresponding job from the job list 12-1 (FIG. 1). Then, the process returns to step S1-31, and ends after passing through step S1-32.

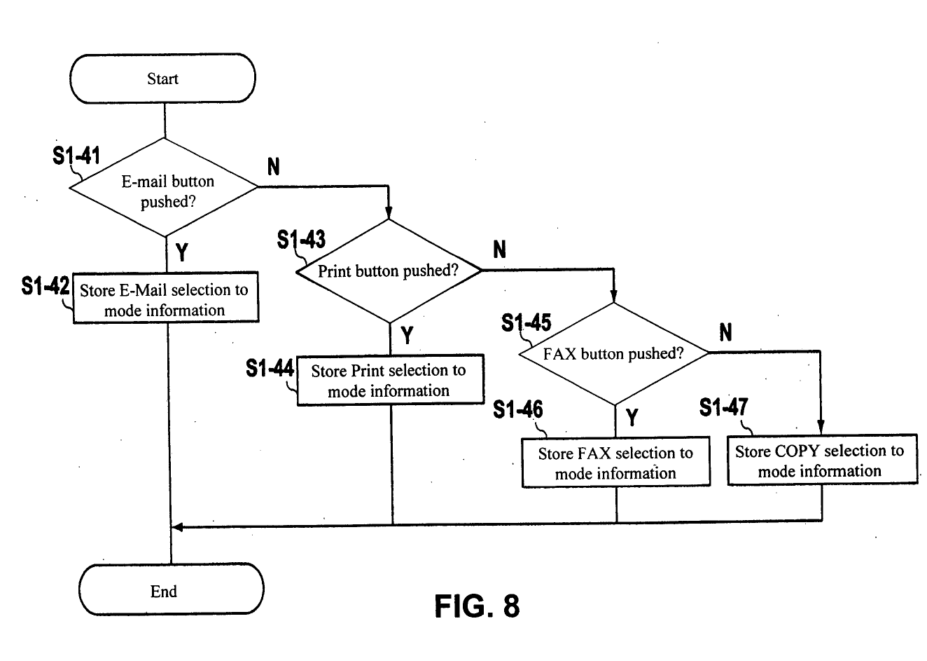

FIG. 8 is a flow chart showing an operation of the job setting process according to the first embodiment of the present invention. The flow chart is a detailed flow chart of step S1-22 executed according to the user request while step S1-21 is performed.

In step S1-41, the operation input/output control unit 15 (FIG. 1) detects that the user clicks (pushes) one of the buttons in the mode selecting section 15-1 of the panel unit 14 (FIG. 3). When the user clicks (pushes) the E-Mail button, the job control unit 13 (FIG. 1) is notified, and the process proceeds to step S1-42. When the user does not click (push) the E-Mail button, the process proceeds to step S1-43.

In step S1-42, the job control unit 13 (FIG. 1) stores the information that the user clicks (pushes) the E-Mail button in the mode information 12-2 (FIG. 1), thereby completing the process.

In step S1-43, when the operation input/output control unit 15 (FIG. 1) detects that the user clicks (pushes) the Print button, the job control unit 13 (FIG. 1) is notified, and the process proceeds to step S1-44. When the user does not click (push) the Print button, the process proceeds to step S1-45.

In step S1-44, the job control unit 13 (FIG. 1) stores the information that the user clicks (pushes) the Print button in the mode information 12-2 (FIG. 1), thereby completing the process.

In step S1-45, when the operation input/output control unit 15 (FIG. 1) detects that the user clicks (pushes) the FAX button, the job control unit 13 (FIG. 1) is notified, and the process proceeds to step S1-46. When the user does not click (push) the FAX button, the process proceeds to step S1-47.

In step S1-46, the job control unit 13 (FIG. 1) stores the information that the user clicks (pushes) the FAX button in the mode information 12-2 (FIG. 1), thereby completing the process. In step S1-47, the job control unit 13 (FIG. 1) stores the information that the copy process is specified in the mode information 12-2 (FIG. 1), thereby completing the process.

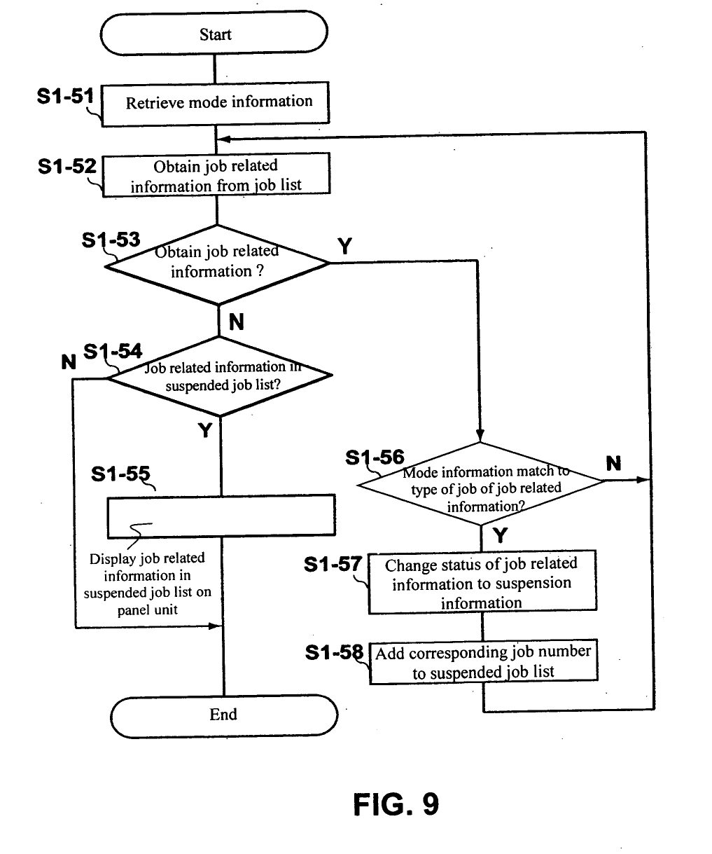

FIG. 9 is a flow chart showing an operation of the job clear pre-processing according to the first embodiment of the present invention. The flow chart is a detailed flow chart of step S1-23.

In step S1-51, the job control unit 13 (FIG. 1) retrieves the mode information 12-2 (FIG. 1). In step S1-52, the job control unit 13 (FIG. 1) obtains the job related information (FIG. 2) from the job list 12-1 (FIG. 1).

In step S1-53, when the job control unit 13 (FIG. 1) finds the job related information from the job list 12-1 (FIG. 1), the process proceeds to step S1-56. When the job control unit 13 (FIG. 1) does not find the job related information, the process proceeds to step S1-54.

In step S1-54, when the job control unit 13 (FIG. 1) finds the job related information from the temporary termination list 12-3 (FIG. 1), the process proceeds to step S1-55. When the job control unit 13 (FIG. 1) does not find the job related information, the process ends.

In step S1-55, the job control unit 13 (FIG. 1) notifies the operation input/output control unit 15 (FIG. 1) of the job related information stored in the temporary termination list 12-3 (FIG. 1). Then, the operation input/output control unit 15 (FIG. 1) displays the contents of the job related information on the cancel list selecting section 15-2 of the panel unit 14 (FIG. 1), thereby completing the process.

In step S1-56, the job control unit 13 (FIG. 1) determines whether the type of job retrieved from the mode information 12-2 (FIG. 1) in step S1-51 matches to the type of job in the job related information obtained in step S1-53. When they are matched, the process proceeds to step S1-57. When they are not matched, the process returns to step S1-52.

In step S1-57, the job control unit 13 (FIG. 1) changes the status information of the job related information to the temporary termination. At this point, the termination process algorism registered in the input/output process algorisms is retrieved and executed.

In step S1-58, the job control unit 13 (FIG. 1) adds the job number to the temporary termination list 12-3 (FIG. 1), and the process returns to step S1-51.

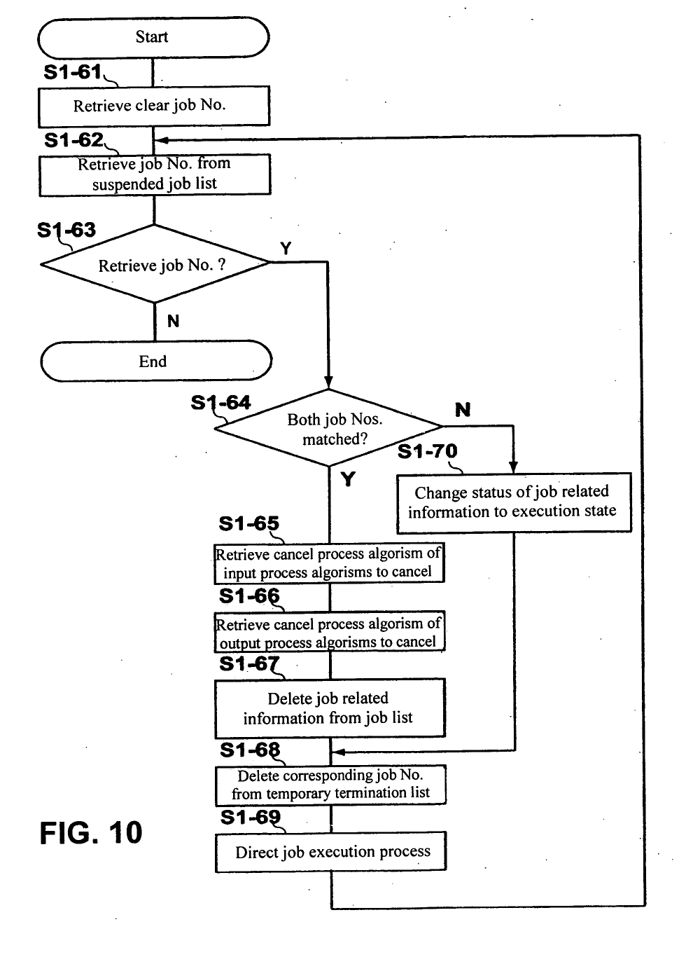

FIG. 10 is a flow chart showing an operation of the job clear process according to the first embodiment of the present invention. The flow chart is a detailed flow chart of step S1-24.

In step S1-61, the job control unit 13 (FIG. 1) obtains the job number that the user clicks (pushes) one of the jobs displayed in the cancel list selecting section 15-2 of the panel unit 14 (FIG. 3) in step S1-55. In step S1-62, the job control unit 13 (FIG. 1) obtains the job number from the temporary termination list 12-3 (FIG. 1). In step S1-63, when the job control unit 13 (FIG. 1) obtains the job number, the process proceeds to step S1-64. When the job control unit 13 (FIG. 1) does not obtain the job number, the process ends.

In step S1-64, when the job number obtained by the job control unit 13 (FIG. 1) in step S1-61 matches the job number obtained in step S1-63, the process proceeds to step S1-65. When they are not matched, the process proceeds to step S1-70.

In step S1-65, the job control unit 13 (FIG. 1) retrieves the cancel process of the input process algorism (FIG. 2) of the job related information corresponding to the matched job number, thereby generating the cancel state. In step S1-66, the job control unit 13 (FIG. 1) retrieves the cancel process of the output process algorism (FIG. 2) of the job related information corresponding to the matched job number, thereby generating the cancel state.

In step S1-67, the job control unit 13 (FIG. 1) deletes the job related information of the job from the job list 12-1 (FIG. 1). In step S1-68, the job control unit 13 (FIG. 1) deletes the job related information of the job from the temporary termination list 12-3 (FIG. 1).

In step S1-69, the job control unit 13 (FIG. 1) directs the execution process of the job, and the process returns to step S1-62. In step S1-70, the job control unit 13 (FIG. 1) changes the status of the job related information to the execution state and cancels the temporary termination state. Then the process returns to step S1-68.

As explained above, the image processing apparatus 100 is provided with the function type specifying unit 16 (FIG. 1). Accordingly, it is possible to temporarily terminate only the processing of the job having the mode same as that of the job that needs to be cleared. As a result, it is not necessary to terminate the jobs having the other modes that do not need to be temporarily terminated, thereby improving processing efficiency of the job.

### Second Embodiment

In the first embodiment of the present invention, the function type specifying unit is provided for specifying the type of mode that the job belongs to. Accordingly, it is possible to temporarily terminate only the process of the job belonging to the mode same as that of the job that is needed to clear. In the second embodiment, instead of the function type specifying unit, a user authentication unit is provided for authenticating a user, so that it is possible to temporarily terminate only a job-related to the same user.

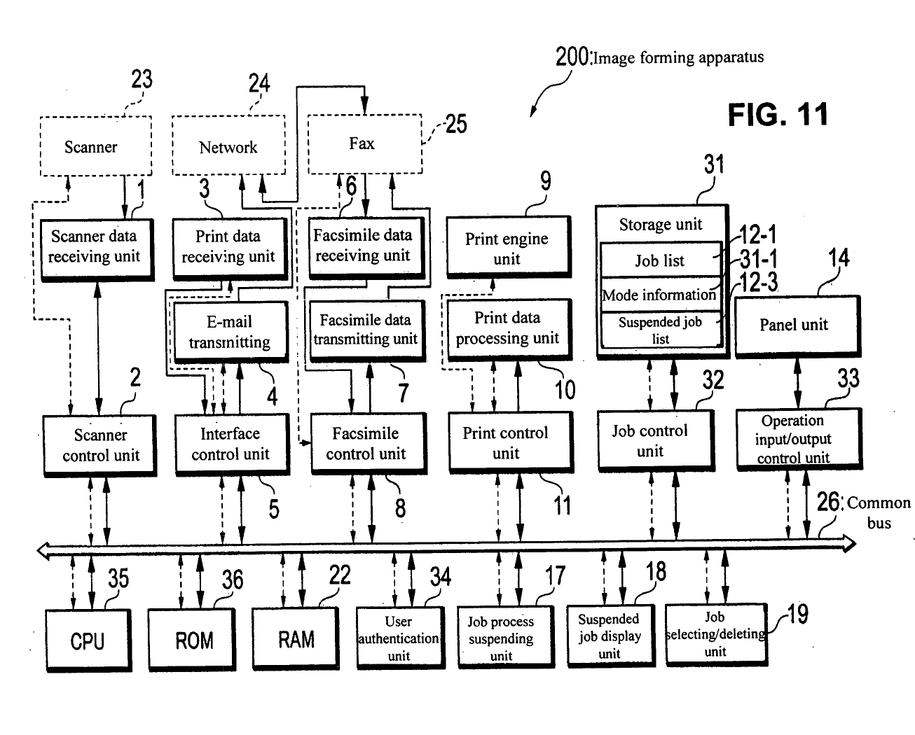

FIG. 11 is a schematic block diagram showing an image forming apparatus 200 according to a second embodiment of the present invention.

As shown in FIG. 11, the image forming apparatus 200 is provided with the scanner data receiving unit 1; the scanner control unit 2; the print data receiving unit 3; the e-mail transmitting unit 4; the interface control unit 5; the facsimile data receiving unit 6; the facsimile data transmitting unit 7; the facsimile control unit 8; the print engine unit 9; the print data processing unit 10; the print control unit 11; a storage unit 31; a job control unit 32; the panel unit 14; an operation input/output control unit 33; the job process terminating unit 17; the terminated job display unit 18; the job selecting/deleting unit 19; a user authentication unit 34; a CPU 35; an ROM 36; the RAM 22; and the common bus 26.

In the second embodiment, the difference from the first embodiment is that the function type specifying unit 16 in the first embodiment is replaced with the user authentication unit 34. In the following description, only the difference from the first embodiment will be explained. Components same as those in the first embodiment are designated by the same reference numerals, and explanations thereof are omitted.

The storage unit 31 is a memory for storing information related to a job according to control of the job control unit 32. In the embodiment, the storage unit 31 includes memory sections for separately storing the job list 12-1; user information 31-1; and the temporary termination list 12-3, respectively. The user information 31-1 is the memory section for storing in advance registration information for specifying a user expected to use the image forming apparatus 200. The registration information for specifying a user include a user name; a user ID; and a password, as well as information of a person in a work group same as that of a user approved to access to a job of the user, and an access range of the person. Further, independent of the registration information, the user information 31-1 is the memory section for storing information of a user requesting for clear of a job. The registration information for specifying a user may be stored in a separate data base (not shown) different from the storage unit 31.

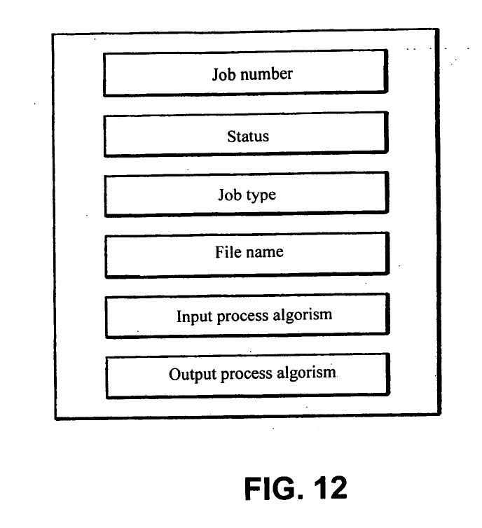

FIG. 12 is a schematic view showing an example of information related to a job according to the second embodiment of the present invention. As shown in FIG. 12, the information related to a job includes a job number of the corresponding job; a status for directing execution, termination, or cancel of the job; a user name; a file name; and process algorism information related to input/output for processing the job.

The job control unit 32 shown in FIG. 11 executes control and operation (execution) of the job using information (FIG. 12) related to the job and stored in the storage unit 31. The job control unit 32 includes blocked computer control functions to be started and created when the CPU 35 executes a specific program stored in advance in the ROM 36.

The operation input/output control unit 33 receives a request from a user through the panel unit 14, and displays contents of the storage unit 31 on the panel unit 14 for providing information for the user. The operation input/output control unit 15, together with the panel unit 14, shares the function of the man-machine interface between the apparatus and a user. The operation input/output control unit 15 includes blocked computer control functions to be started and created when the CPU 35 executes a specific program stored in advance in the ROM 36.

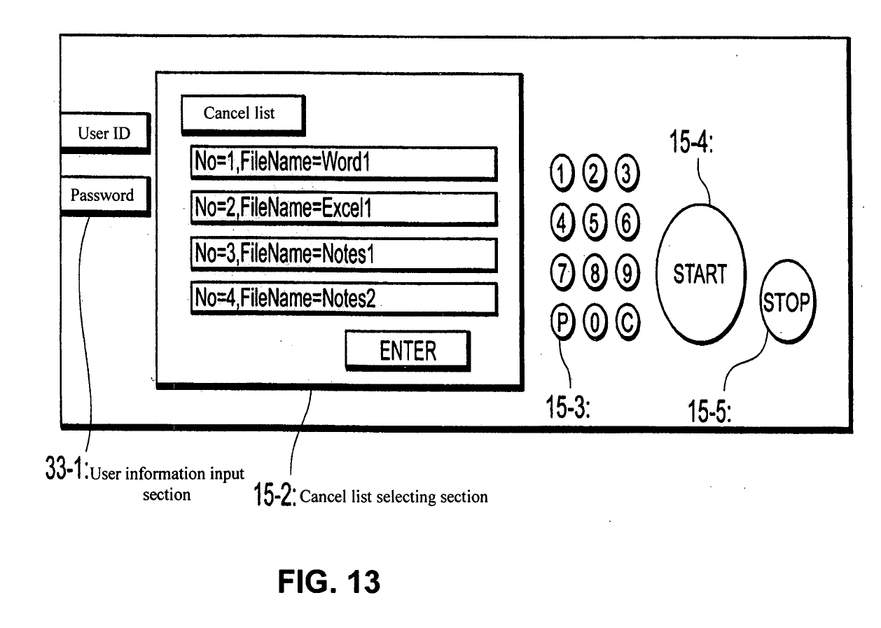

An example of the panel display will be explained next. FIG. 13 is a schematic view showing an example of the panel display according to the second embodiment of the present invention. As shown in FIG. 13, there are arranged a user information input section 33-1 for inputting user information (user ID and password) that a user requests for temporarily terminating a job; a cancel list selecting section 15-2 for selecting a job that a user requests for clearing thereof; a ten-key 15-3 for inputting data; a start switch 15-4; and a stop switch 15-5.

When the scanner data receiving unit 1, the print data receiving unit 3, or the facsimile data receiving unit 6 receives the scanner data, print data, or facsimile data, respectively, the user authentication unit 34 shown in FIG. 11 receives the user information (user ID and password attached to the various data) of the user. Then, the user authentication unit 34 compares the user information with the registered user information registered in advance in the storage unit 31 for authenticating the user. Further, the user authentication unit 34 compares the user information (user ID and password) that the user inputs in the user information input section 33-1 of the panel unit 14 (FIG. 13) for clearing the job with the registered user information in the storage unit 31 for authenticating the user. The user authentication unit 34 includes blocked computer control functions to be started and created when the CPU 35 executes a specific program stored in advance in the ROM 36.

The CPU 35 shown in FIG. 13 is a microprocessor for controlling the apparatus as a whole. In the embodiment, when the CPU 35 executes a specific program stored in the ROM 36, it is possible to start and create the scanner control unit 2; the interface control unit 5; the facsimile control unit 8; the print control unit 11; the job control unit 32; the operation input/output control unit 33; the user authentication unit 34; the job process terminating unit 17; the terminated job display unit 18; and the job selecting/deleting unit 19.

The ROM 36 is a read-only memory for storing a control program, so that when the CPU 35 executes the control program, it is possible to start and create the scanner control unit 2; the interface control unit 5; the facsimile control unit 8; the print control unit 11; the job control unit 32; the operation input/output control unit 33; the user authentication unit 34; the job process terminating unit 17; the terminated job display unit 18; and the job selecting/deleting unit 19. The RAM 22 is a random access memory for providing an algorism processing area necessary for the CPU 20 to execute the control program.

An operation of the image forming apparatus according to the second embodiment of the present invention will be explained next. First, an operation will be explained, in which the image forming apparatus 200 receives the various data to create a job, and the information related to the job (job related information) is stored in the storage unit 31. Second, an operation will be explained, in which the specific job among the jobs is cleared according to the user request.

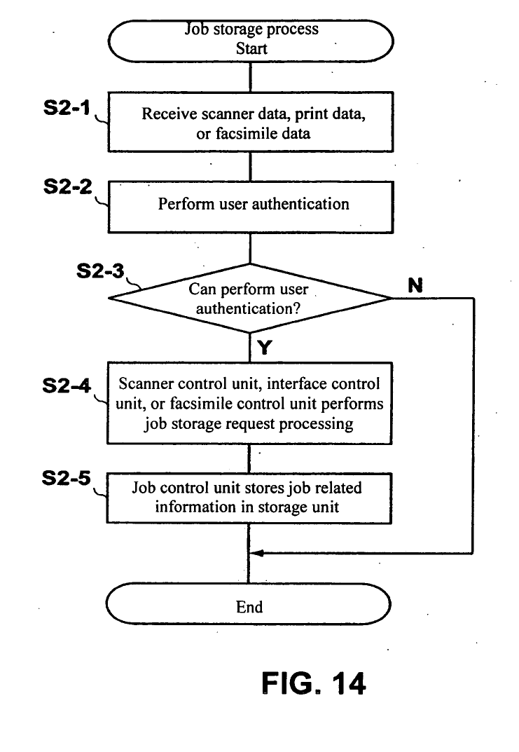

FIG. 14 is a flow chart showing an operation of a job storage process according to the second embodiment of the present invention. In the operation, it is assumed that the registered user information is stored in the user information 31-1 of the storage unit 31 (FIG. 11) in advance. Further, it is assumed that the information to be obtained from the scanner data receiving unit 1 (FIG. 1), the print data receiving unit 3 (FIG. 1), and the facsimile data receiving unit 6 (FIG. 1) includes account information of the user (user ID) and a password.

In step S2-1, the scanner data receiving unit 1 (FIG. 11) receives the scanner data and sends the scanner data to the scanner control unit 2 (FIG. 11). Alternatively, the print data receiving unit 3 (FIG. 11) receives the print data and sends the print data to the interface control unit 5 (FIG. 11). Alternatively, the facsimile data receiving unit 6 (FIG. 11) receives the facsimile data and sends the facsimile data to the facsimile control unit 8 (FIG. 11).

In step S2-2, the user authentication unit 34 (FIG. 11) performs the user authentication according to the account information of the user (user ID) and the password included in the received or obtained data (described later). In step S2-3, when the user authentication unit 34 (FIG. 11) performs the user authentication, the process proceeds to step S2-4. When the user authentication unit 34 (FIG. 11) cannot perform the user authentication, the process ends.

In step S2-4, the scanner control unit 2 (FIG. 11), the interface control unit 5 (FIG. 11), or the facsimile control unit 8 (FIG. 11) creates the job according to the received data, and temporarily stores the job in the scanner data receiving unit 1 (FIG. 11), the print data receiving unit 3 (FIG. 11), or the facsimile data receiving unit 6 (FIG. 11). Further, the scanner control unit 2 (FIG. 11), the interface control unit 5 (FIG. 11), or the facsimile control unit 8 (FIG. 11) sends the job related information to the job control unit 32 (FIG. 11) for requesting the job related information to be stored therein (described later). In step S2-5, the job control unit 32 (FIG. 11) stores the job related information in the job list 12-1 of the storage unit 12 (FIG. 11), thereby completing the process.

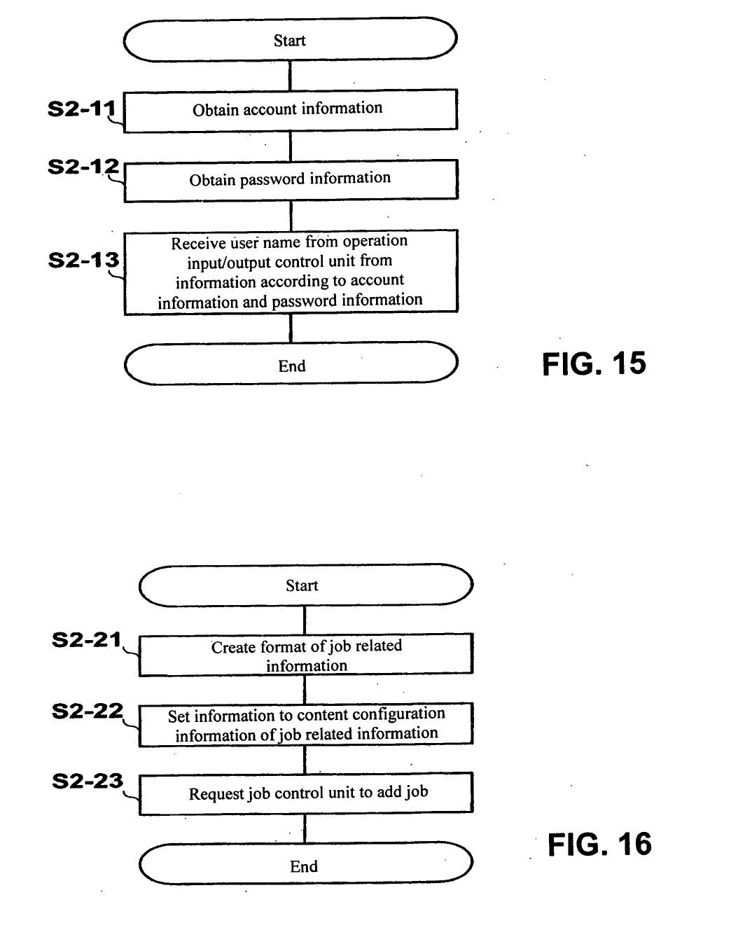

The process in step S2-2 will be explained in more detail with reference to another flow chart. FIG. 15 is a flow chart showing an operation of the user authentication process according to the second embodiment of the present invention.

In step S2-11, the scanner control unit 2 (FIG. 11), the interface control unit 5 (FIG. 11), or the facsimile control unit 8 (FIG. 11) obtains the account information (user ID) from the obtained or received data. The account information may be stored in the data, or may be notified from the operation input/output control unit 33 separated from the data.

In step S2-12, the scanner data receiving unit 1 (FIG. 11), the print data receiving unit 3 (FIG. 11), or the facsimile data receiving unit 6 (FIG. 11) obtains the password information from the obtained or received data. The password information may be stored in the data, or may be notified from the operation input/output control unit 33 separated from the data.

In step S2-13, the user authentication unit 34 (FIG. 11) receives the user ID and the password information from the scanner data receiving unit 1 (FIG. 11), the print data receiving unit 3 (FIG. 11), or the facsimile data receiving unit 6 (FIG. 11). Then, the user authentication unit 34 (FIG. 11) compares the user ID and the password information with the registered contents of the user information 31-1 (FIG. 11) through the job control unit 32 for the user authentication, thereby completing the process.

FIG. 16 is a flow chart showing an operation of the request for storing the information related to the job according to the second embodiment of the present invention. The flow chart shows a detailed process in step S2-4.

In step S2-21, when the scanner control unit 2 (FIG. 11) receives the scanner data from the scanner data receiving unit 1 (FIG. 11), or the interface control unit 5 (FIG. 11) receives the print data from the print data receiving unit 3 (FIG. 11), or the facsimile control unit 8 (FIG. 11) receives the facsimile data from the facsimile data receiving unit 6 (FIG. 11), the respective control unit (the scanner control unit 2 (FIG. 11), the interface control unit 5 (FIG. 11), or the facsimile control unit 8 (FIG. 11)) creates the job and temporarily stores the job in the corresponding receiving unit (the scanner data receiving unit 1 (FIG. 11), the print data receiving unit 3 (FIG. 11), or the facsimile data receiving unit 6 (FIG. 11)). Further, the respective control unit (the scanner control unit 2 (FIG. 11), the interface control unit 5 (FIG. 11), or the facsimile control unit 8 (FIG. 11)) creates the format of the job related information (FIG. 12).

In step S2-22, the respective control unit (the scanner control unit 2 (FIG. 11), the interface control unit 5 (FIG. 11), or the facsimile control unit 8 (FIG. 11)) sets the job related information (the job number, the user name, the file name, and the process algorism information for input/output shown in FIG. 12) to the format of the job related information shown in FIG. 12.

In step S2-23, the respective control unit (the scanner control unit 2 (FIG. 11), the interface control unit 5 (FIG. 11), or the facsimile control unit 8 (FIG. 11)) sends the job related information to the job control unit 13 (FIG. 11) for adding to the job list, thereby completing the process.

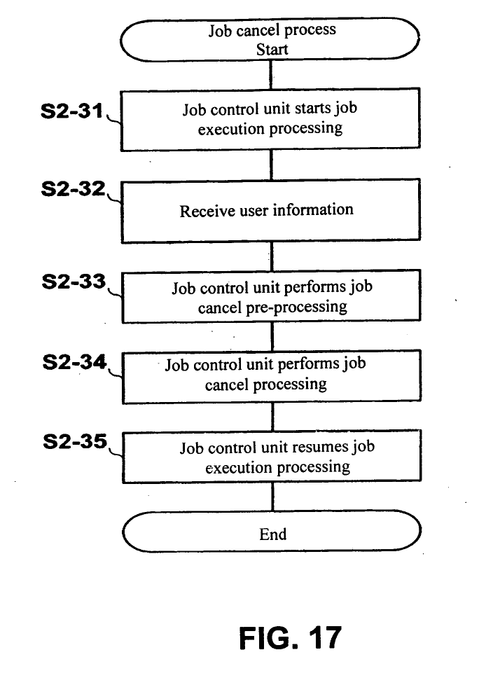

FIG. 17 is a flow chart showing an operation of the job clear process according to the second embodiment of the present invention.

In step S2-31, the job control unit 32 (FIG. 11) starts the operation (execution) of the job in a specific order (refer to FIG. 7 in the first embodiment). That is, the execution process of the job is started. In step S2-32, during the execution process of the job, the job control unit 32 (FIG. 11) receives the user request (input to the panel unit 14 (FIG. 11)). Further, the operation input/output control unit 33 obtains the input user information that the user inputs in the user information input section 33-1.

In step S2-33, the job control unit 32 (FIG. 11) performs a specific pre-processing (described later) for clearing the job. In step S2-34, the job control unit 32 (FIG. 11) clears the job in a specific order (refer to FIG. 10 in the first embodiment). In step S2-35, the job control unit 32 (FIG. 11) resumes the operation (execution) of the job in a specific order.

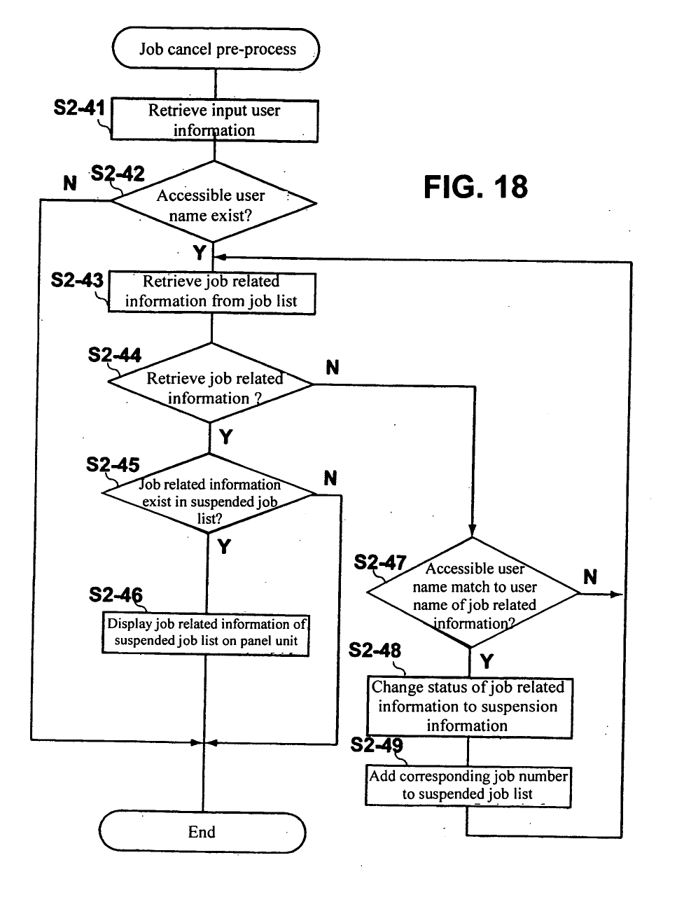

FIG. 18 is a flow chart showing an operation of a job clear pre-processing according to the second embodiment of the present invention. The flow chart shows a detailed process in step S2-33.

In step S2-41, the job control unit 32 (FIG. 11) retrieves the user information of the user requesting for clearing the job temporarily stored in the user information 31-1 of the storage unit 31 (FIG. 11). In step S2-42, the job control unit 32 (FIG. 11) searches for the registered user information stored in advance in the user information 31-1 (FIG. 11) to determine whether the access is possible. When the access is possible, the process proceeds to step S2-43. When the access is not possible, the process ends.

In step S2-43, the job control unit 32 (FIG. 11) retrieves the job related information from the job list 12-1 (FIG. 11). In step S2-44, when the job control unit 32 (FIG. 11) retrieves the job related information, the process proceeds to step S2-45. When the job control unit 32 (FIG. 11) cannot retrieve the job related information, the process proceeds to step S2-47.

In step S2-45, when the job control unit 32 (FIG. 11) finds the job related information from the temporary termination list 12-3 (FIG. 11), the process proceeds to step S2-46. When the job control unit 32 (FIG. 11) cannot find the job related information, the process ends.

In step S2-46, the job control unit 32 (FIG. 11) notifies the operation input/output control unit 33 (FIG. 11) of the job related information stored in the temporary termination list 12-3 (FIG. 11), and the operation input/output control unit 33 (FIG. 11) displays the contents of the job related information on the panel unit 14 (FIG. 11) as the cancel list selecting section 15-2 (FIG. 13), thereby completing the process.

In step S2-47, the job control unit 32 (FIG. 11) determines whether the user information retrieved from the user information 13-1 (FIG. 11) in step S2-41 matches to the user name in the job related information obtained in step S2-43. When they are matched, the process proceeds to step S2-48. When they are not matched, the process returns to step S2-43.

In step S2-48, the job control unit 32 (FIG. 11) changes the status information of the job related information (FIG. 12) to the temporary termination. In step S2-49, the job control unit 32 (FIG. 11) adds the job number to the temporary termination list 12-3 (FIG. 11), and the process returns to step S1-51. Other steps of the process are the same as those in the first embodiment, and explanations thereof are omitted.

As described above, in the second embodiment, it is possible to specify the job to be cleared for each user requesting for clearing the job. Accordingly, it is possible to securely clear the job without terminating the jobs not subjected to clearing. Further, it is possible to prevent other person from inadvertently clearing unrelated jobs.

In the embodiments, the scanning device and the facsimile device represent the components separated from the image forming apparatus, and the present invention is not limited to such a configuration. The image forming apparatus may be integrated with the scanning device and the facsimile device.

The disclosure of Japanese Patent Application No. 2005-379033, filed on Dec. 28, 2005, is incorporated in the application.

While the invention has been explained with reference to the specific embodiments of the invention, the explanation is illustrative and the invention is limited only by the appended claims.

What is claimed is:

1. An image processing apparatus, comprising:
a job storage unit for receiving and storing a plurality of first jobs together with characteristic information of the first jobs;
a characteristic information specifying unit for specifying information corresponding to the characteristic information;
a job searching unit for searching for a second job having the information specified by the characteristic information specifying unit from the first jobs stored in the job storage unit; and
a job terminating unit for temporarily terminating the second job found by the job searching unit.

2. The image processing apparatus according to claim 1, further comprising a job display unit for displaying the second job searched by the job searching unit; a job information input unit for inputting job information selected by a user; and a job deleting unit for deleting a third job corresponding to the job information input through the job information input unit from the first jobs stored in the job storage unit when the third job is in the second job found by the job searching unit.

3. The image processing apparatus according to claim 1, wherein said characteristic information specifying unit specifies the information including types of image processing functions of the image processing apparatus.

4. The image processing apparatus according to claim 1, wherein said characteristic information specifying unit specifies the information including user information of a user requesting the job for authenticating the user.

5. The image processing apparatus according to claim 1, wherein said characteristic information specifying unit specifies the information including a number corresponding to the characteristic information.

6. The image processing apparatus according to claim 2, wherein said job information input unit is arranged for inputting the job information including a file name.
